(19) United States
(12) Patent Application Publication
(10) Pub. No.: US 2008/0203642 A1
(43) Pub. Date: Aug. 28, 2008

(54) APPARATUS AND METHOD FOR POSITIONING A WORKPIECE IN A WORKING ORIENTATION

(75) Inventors: Scott A. Martin, Swansea, IL (US); Dustin D. Ribble, Piasa, IL (US); Darrin R. Arnold, Godfrey, IL (US)

Correspondence Address: LAW OFFICE OF DONALD D. MONDUL, 3060 BONSAI DRIVE, PLANO, TX, 75093, US

(73) Assignee: BOEING COMPANY, A CORPORATION OF DELAWARE, Chicago, IL (US)

(21) Appl. No.: 11/680,007

(22) Filed: Feb. 28, 2007

(51) Int. Cl. B23Q 3/00

(52) U.S. Cl. 269/289 R

(57) ABSTRACT

An apparatus for positioning a workpiece in a working orientation with respect to a portable operating device when the apparatus is in an assembled orientation, the operating device cooperating with the apparatus to apply at least one operating element to the workpiece at least one predetermined work site when the workpiece is in the working orientation, includes: (a) a base unit configured for effecting a first cooperative fitting with the operating device in a first orientation; (b) a receiving unit configured for effecting a second cooperative fitting with the workpiece in a second orientation; and (c) an orienting structure configured for effecting a third cooperative fitting the receiving unit with the base unit to situate the apparatus in the assembled orientation.

### BACKGROUND OF THE INVENTION

The present invention is directed to automatic manufacturing fixtures, and especially to automatic manufacturing fixtures positioning a workpiece in a predetermined working orientation with respect to a portable operating device when the fixture is in an assembled orientation.

Manually operating equipment to provide sufficient pressure to effect working of a workpiece, as by way of example and not by way of limitation, by drilling can cause equipment operators to suffer fatigue and injury. Representative injuries to workers may include ergonomic problems with elbows, shoulders and wrists. Fatigue and injuries may be especially pronounced when a workpiece is configured of hard material, such as by way of example and not by way of limitation, titanium.

Manually locating a work site at which to perform an operation, such as by way of example and not by way of limitation measuring and scribing each individual workpiece, provides opportunities for inaccuracy in work site placement. Maintaining operating equipment in a precise location for carrying out work may require more energy that may further contribute to equipment operators' fatigue and injury.

One solution may be to perform the desired operation using an automated machine, such as a drill press. However, such a large machine may be expensive, may occupy a relatively large space, and may not be available or amenable for use on a crowded manufacturing floor, such as may be involved in fabricating an aircraft. A portable operating device for performing operations in manufacturing parts may be desired, especially when it is desired to minimize cost and space for performing operations.

There is a need for an apparatus and method for positioning a workpiece in a predetermined working orientation with respect to a portable operating device.

### SUMMARY OF THE INVENTION

An apparatus for positioning a workpiece in a working orientation with respect to a portable operating device when the apparatus is in an assembled orientation, the operating device cooperating with the apparatus to apply at least one operating element to the workpiece at least one predetermined work site when the workpiece is in the working orientation, includes: (a) a base unit configured for effecting a first cooperative fitting with the operating device in a first orientation; (b) a receiving unit configured for effecting a second cooperative fitting with the workpiece in a second orientation; and (c) an orienting structure configured for effecting a third cooperative fitting the receiving unit with the base unit to situate the apparatus in the assembled orientation.

A method for positioning a workpiece in a predetermined working orientation with respect to a portable operating device when the apparatus is in an assembled orientation, the operating device cooperating with the apparatus to apply at least one operating element to the workpiece at least one predetermined work site when the workpiece is in the working orientation, includes the steps of: (a) in no particular order: (1) providing a base unit configured for effecting a first cooperative fitting with the operating device in a first orientation; (2) providing a receiving unit configured for effecting a second cooperative fitting with the workpiece in a second orientation; and (3) providing an orienting structure configured for effecting a third cooperative fitting the receiving unit with the base unit; and (b) situating the base unit, the receiving unit and the orienting structure in the assembled orientation.

It is, therefore, a feature of the present invention to provide an apparatus and method for positioning a workpiece in a predetermined working orientation with respect to a portable operating device.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a top plan view of a base unit configured for use with the present invention.

FIG. 2 is a side elevation view of the base unit illustrated in FIG. 1.

FIG. 3 is a side elevation view of a first embodiment of the apparatus of the present invention employed with a portable operating device and a workpiece.

FIG. 4 is a top plan view of a base unit and receiving structure employed in a second embodiment of the apparatus of present invention having hold-down structures.

FIG. 5 is a perspective view of the second embodiment of the apparatus of present invention illustrated in FIG. 4.

FIG. 6 is a flow chart illustrating the method of the present invention.

### DETAILED DESCRIPTION OF THE PREFERRED EMBODIMENT

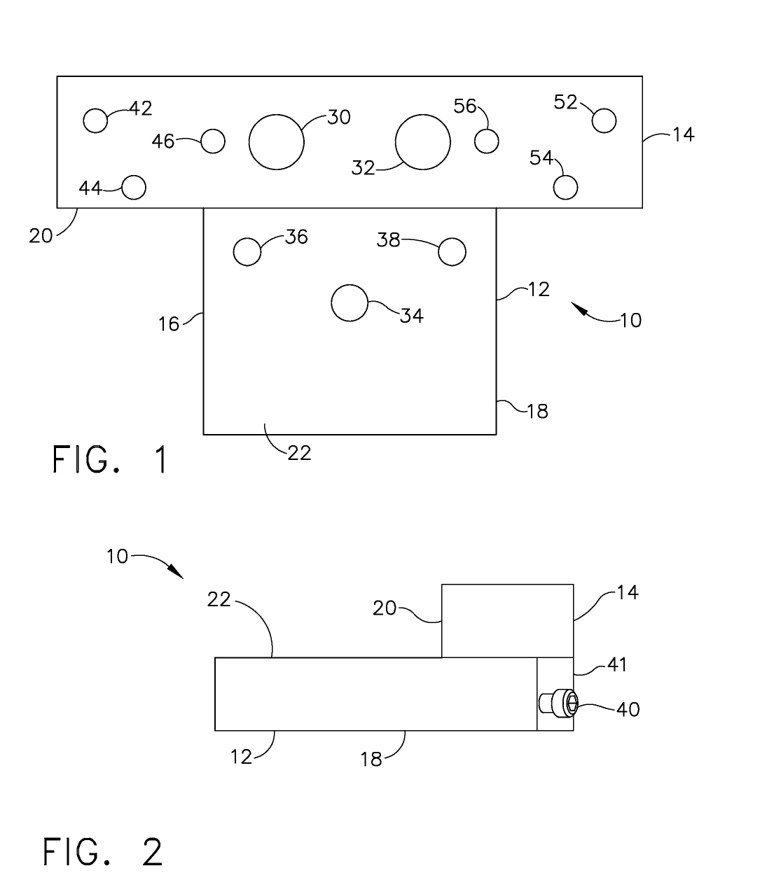

FIG. 1 is a top plan view of a base unit configured for use with the present invention. FIG. 2 is a side elevation view of the base unit illustrated in FIG. 1. Considering FIGS. 1 and 2 together, a base unit 10 may include a foundation portion 12 and a block portion 14. Block portion 14 may preferably be integrally formed with foundation portion 12. Block portion 14 may extend beyond edges 16, 18 of foundation portion 12 to present an elongated stop 20 generally perpendicular with edges 16, 18. Foundation portion 12 may present a generally planar face 22 between edges 16, 18. Stop 20 may be generally perpendicular with face 22.

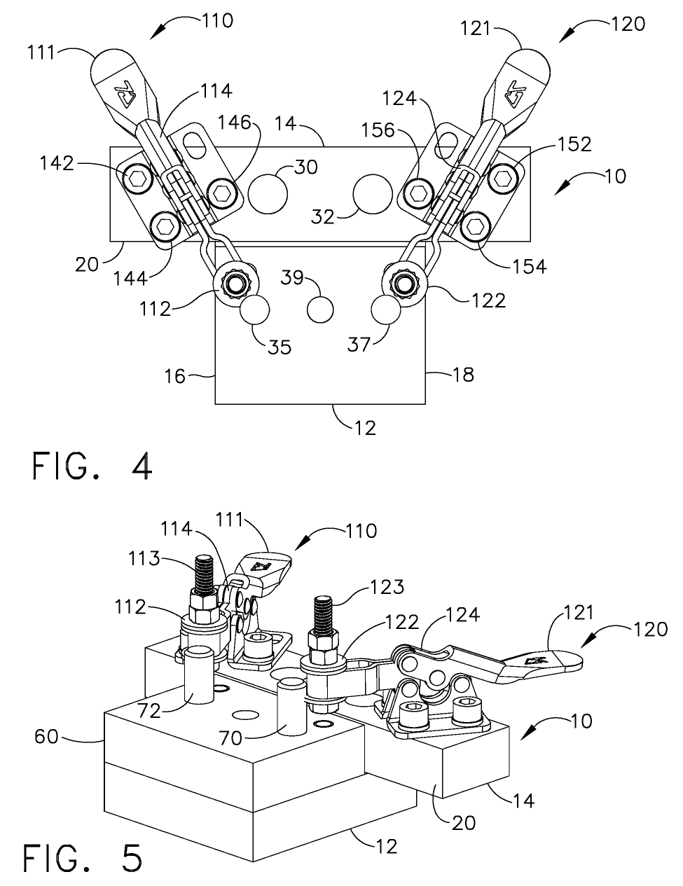

A plurality of representative apertures are illustrated in base unit 10. Apertures 30, 32 may preferably traverse block portion 14. Apertures 30, 32 may be configured as guide rod receiver apertures for receiving guide rod structures associated with a portable operation device, such as a portable drill (better seen in FIG. 4). Aperture 34 may preferably traverse foundation portion 12. Aperture 34 may be configured for permitting an operating member, such as a drill, to substantially fully traverse a workpiece situated in a generally abutting relation with face 22 (not shown in FIGS. 1 and 2; see FIG. 4). Apertures 36, 38 may fully traverse foundation portion 12, but need not necessarily traverse foundation portion 12. Apertures 36, 38 may be employed with inserted pin members (not shown in FIGS. 1 and 2) for substantially fixedly locating a receiving unit (not shown in FIGS. 1 and 2; see FIG. 4) with respect to base unit 10. A set screw 40 may traverse block member 14 to intersect aperture 32. Set screw 40 may be advanced into aperture 32 when a guide rod structure (not shown in FIGS. 1 and 2; see FIG. 4) is inserted in aperture 32 to bear against an inserted guide rod structure to effect substantially locking the guide rod structure within aperture 32. A similar set screw (not visible in FIGS. 1 and 2) may preferably be provided for effecting an interference fit with a guide rod structure situated within aperture 30. By such a locking relationship with guide rod structures inserted within apertures 30, 32 base member 10 may be substantially fixedly oriented with an operating device (see FIG. 4). An oblique wall 41 oriented to establish an acute angle with edge 18 may be provided to facilitate traversing of block member 14 by set screw 40. A similar oblique wall (not visible in FIGS. 1 and 2) may also be provided to facilitate traversing of block member 14 by another set screw into aperture 30.

Additional apertures 42, 44, 46, 52, 54, 56 may be provided in block portion 14 for attaching clamping members (not shown in FIGS. 1 and 2) in a second embodiment of the present invention, described in greater detail in connection with FIGS. 4 and 5 below.

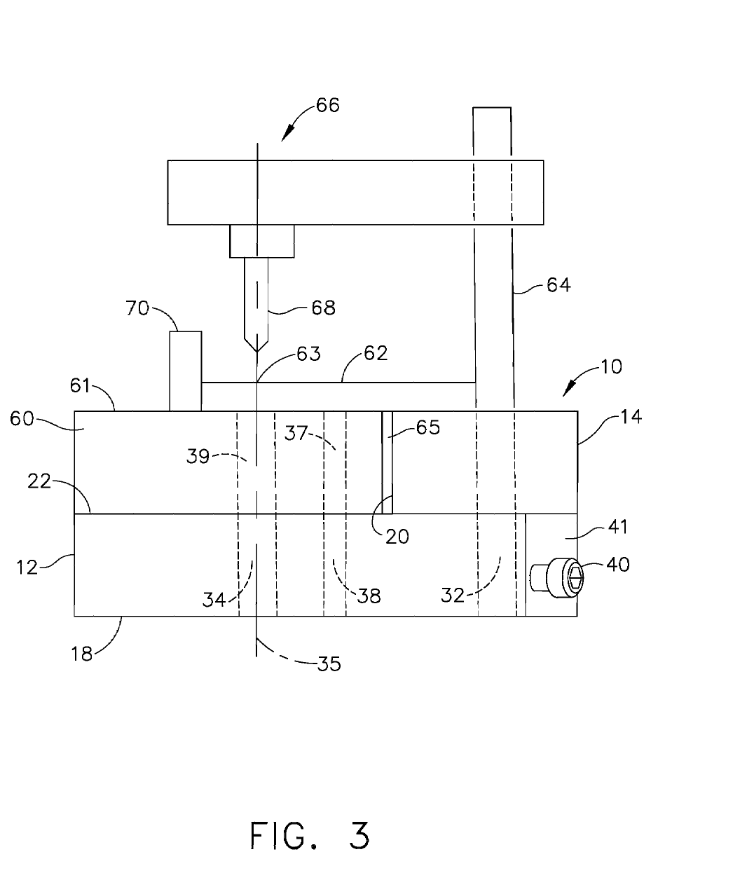

FIG. 3 is a side elevation view of a first embodiment of the apparatus of the present invention employed with a portable operating device and a workpiece. In FIG. 3, a receiving unit 60 may substantially abut face 22 of foundation portion 12. Receiving unit 60 may be situated in spaced relation with respect to a block portion 14 to establish a gap 65 between receiving unit 60 and stop 20. If desired, receiving unit 60 may substantially abut stop 20 thereby substantially eliminating gap 65. Receiving unit 60 may be held in lateral position with respect to foundation portion 12 by a pin inserted within substantially aligned apertures 38, 39 (and, if desired, by a pin in another aperture substantially aligned with aperture 36; not visible in FIG. 3; see FIG. 1). Fixing lateral position of receiving unit 60 with respect to foundation portion 12 may substantially restrict movement of receiving unit 60 in directions generally parallel with face 22.

A structure 70 may extend from a generally planar face 61 of receiving unit 60. Structure 70 may be embodied in a pin (with other pins, if desired, not visible in FIG. 3), a wall, or another structure appropriate to cooperate with workpiece 62 to substantially laterally fix a workpiece 62 with respect to receiving unit 60. Fixing lateral position of workpiece 62 with respect to receiving unit 60 may substantially restrict movement of workpiece 62 in directions generally parallel with face 61 of receiving unit 60. Workpiece 62 may be configured to cooperate with structure 70 for laterally fixing workpiece 62. By way of example and not by way of limitation, workpiece 62 may include apertures (not shown in FIG. 3) through which a pin embodiment of structure 70 may be inserted to effect lateral fixing of workpiece 62. By way of further example and not by way of limitation, workpiece 62 may include edge depressions (not shown in FIG. 3) into which a pin or other embodiment of structure 70 may be nestled to effect lateral fixing of workpiece 62. Other cooperative structures provided in workpiece 62 and structure 70 may also be used, alone or in any combination, to effect lateral fixing of workpiece 62.

A portable operating device 66 may present guide rod structure 64 within aperture 32 (a similar guide rod structure not visible in FIG. 3 is preferably also presented within aperture 30; FIG. 1). Set screw 40 may affix guide rod structure 64 with respect to base member 10, thereby fixing operating device 66 with respect to base unit 10. A set screw extending into aperture 30 (not visible in FIG. 3) may affix another guide rod structure within aperture 30 with respect to base member 10. By such structure, operating device 66 may be fixed with respect to base unit 10. Workpiece 62 may be laterally fixed with respect to orienting structure 60. Orienting structure 60 may be laterally fixed with respect to foundation portion 12 of base member 10. When thus mutually affixed in an assembled orientation as illustrated in FIG. 3, aperture 34 and a coaxial aperture 39 in receiving unit 60 may be aligned with an axis 35. Axis 35 may intersect workpiece 62 at a work locus or work site 63. An operating element 68 affixed with operating device 66 may be applied to perform an action upon workpiece 62 at work site 63. In the exemplary embodiment operating element 68 is illustrated as a drill bit appropriate for drilling an aperture in workpiece 62 at work site 63. Other functions or actions by other operating elements may be employed without departing from the scope of the present invention.

FIG. 4 is a top plan view of a base unit and receiving structure employed in a second embodiment of the apparatus of present invention having hold-down structures. FIG. 5 is a perspective view of the second embodiment of the apparatus of present invention illustrated in FIG. 4. Considering FIGS. 4 and 5 together, receiving unit 60 may substantially abut foundation portion 12 generally as described above in connection with FIG. 3. Receiving unit 60 may be held in lateral position with respect to foundation portion 12 by a pin inserted within apertures 35, 37, and extending into substantially aligned apertures in foundation portion 12 (e.g., apertures 36, 38; FIG. 1) substantially aligned apertures 35, 37.

Structures 70, 72 may extend from receiving unit 60. Structures 70, 72 may be embodied in a pin, a wall, or another structure appropriate to cooperate to substantially laterally fix a workpiece 62 with respect to receiving unit 60. Structures 70, 72 are illustratively represented in FIG. 5 as pins 70, 72 for interacting with a workpiece (not shown in FIG. 5) to hold the workpiece substantially fixed with respect to receiving unit 60.

Clamping units 110, 120 may be included in the embodiment of the invention illustrated in FIGS. 4 and 5. Clamping units 110, 120 may operate to hold a workpiece against receiving unit 60 in order to resist a pulling away from receiving unit 60 by a workpiece when an operating element (e.g., operating element 68; FIG. 3) is withdrawn from the workpiece (e.g., workpiece 62; FIG. 3).

Clamping unit 110 may include an actuator handle 111 coupled with a rotating-locking mechanism 114. Also coupled with rotating-locking mechanism 114 may be a clamp contact member 112. Clamp contact member 112 may include an adjustment mechanism 113 for adjusting clearance between clamp contact member 112 and receiving unit 60 so that workpieces of varying thicknesses may be clampingly accommodated by clamping unit 110.

Clamping unit 120 may include an actuator handle 121 coupled with a rotating-locking mechanism 124. Also coupled with rotating-locking mechanism 124 may be a clamp contact member 122. Clamp contact member 122 may include an adjustment mechanism 123 for adjusting clearance between clamp contact member 122 and receiving unit 60 so that workpieces of varying thicknesses may be clampingly accommodated by clamping unit 120.

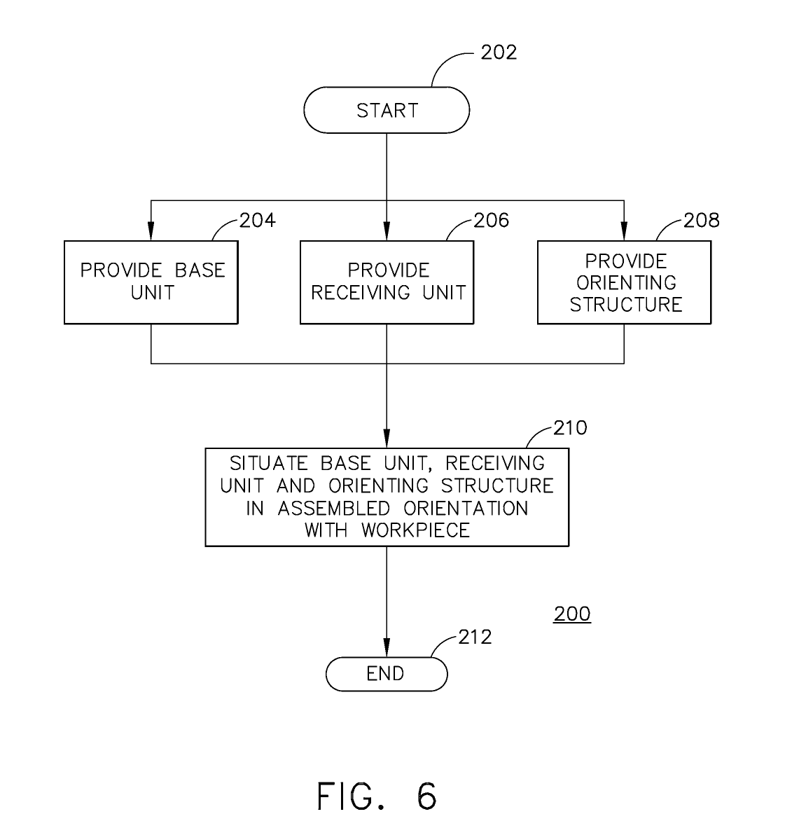

FIG. 6 is a flow chart illustrating the method of the present invention. In FIG. 6, a method 200 for positioning a workpiece in a predetermined working orientation with respect to a portable operating device when the apparatus is in an assembled orientation may begin at a START locus 200. The operating device cooperates with the apparatus to apply at least one operating element to the workpiece at least one predetermined work site when the workpiece is in the working orientation. Method 200 continues by, in no particular order: (1) providing a base unit configured for effecting a first cooperative fitting with the operating device in a first orientation, as indicated by a block 204; (2) providing a receiving unit configured for effecting a second cooperative fitting with the workpiece in a second orientation, as indicated by a block 206; and (3) providing an orienting structure configured for effecting a third cooperative fitting the receiving unit with the base unit, as indicated by a block 208. Method 200 continues by situating the base unit, the receiving unit and the orienting structure in the assembled orientation, as indicated by a block 210. Method 200 terminates at an END locus 212.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following

I claim:

1. An apparatus for positioning a workpiece in a working orientation with respect to a portable operating device when the apparatus is in an assembled orientation; said operating device cooperating with the apparatus to apply at least one operating element to said workpiece at least one predetermined work site when said workpiece is in said working orientation; the apparatus comprising:
(a) a base unit configured for effecting a first cooperative fitting with said operating device in a first orientation;
(b) a receiving unit configured for effecting a second cooperative fitting with said workpiece in a second orientation; and
(c) an orienting structure configured for effecting a third cooperative fitting said receiving unit with said base unit to situate the apparatus in said assembled orientation.

2. An apparatus for positioning a workpiece in a working orientation with respect to a portable operating device as recited in claim 1 wherein said operating device includes at least one guide rod structure; said at least one guide rod structure participating in guiding said operating element to said work site; and wherein said base unit presents at least one guide rod receiver; said at least one guide rod receiver cooperating with said at least one guide structure to effect said first cooperative fitting.

3. An apparatus for positioning a workpiece in a working orientation with respect to a portable operating device as recited in claim 1 wherein said receiving unit presents a plurality of structures depending from a substantially planar face; said workpiece being received substantially abutting said face; said plurality of structures cooperating to limit movement of said workpiece in directions generally parallel with said face to effect said second cooperative fitting.

4. An apparatus for positioning a workpiece in a working orientation with respect to a portable operating device as recited in claim 1 wherein the apparatus further comprises at least one clamping unit coupled with at least one of said base unit and said receiving unit; said at least one clamping unit being configured for urging said workpiece toward said base unit when the apparatus is in said assembled orientation.

5. An apparatus for positioning a workpiece in a working orientation with respect to a portable operating device as recited in claim 1 wherein said third cooperative fitting is effected by cooperation among a plurality of pin structures received within a plurality of aperture structures; said plurality of pin structures and said plurality of aperture structures being distributed between said orienting structure and said receiving unit.

6. An apparatus for positioning a workpiece in a working orientation with respect to a portable operating device as recited in claim 2 wherein said third cooperative fitting is effected by cooperation among a plurality of pin structures received within a plurality of aperture structures; said plurality of pin structures and said plurality of aperture structures being distributed between said orienting structure and said receiving unit.

7. An apparatus for positioning a workpiece in a working orientation with respect to a portable operating device as recited in claim 2 wherein said receiving unit presents a plurality of structures depending from a substantially planar face; said workpiece being received substantially abutting said face; said plurality of structures cooperating to limit movement of said workpiece in directions generally parallel with said face to effect said second cooperative fitting.

8. An apparatus for positioning a workpiece in a working orientation with respect to a portable operating device as recited in claim 7 wherein said third cooperative fitting is effected by cooperation among a plurality of pin structures received within a plurality of aperture structures; said plurality of pin structures and said plurality of aperture structures being distributed between said orienting structure and said receiving unit.

9. An apparatus for positioning a workpiece in a working orientation with respect to a portable operating device as recited in claim 8 wherein the apparatus further comprises at least one clamping unit coupled with at least one of said base unit and said receiving unit; said at least one clamping unit being configured for urging said workpiece toward said base unit when the apparatus is in said assembled orientation.

10. An apparatus for fixing a workpiece with respect to a portable operating device for performing an operation at a work site on said workpiece; the apparatus comprising:
(a) a first orienting structure configured for attachment with said operating device in a first substantially fixed orientation;
(b) a second orienting structure configured for positioning said workpiece in a second substantially fixed orientation; and
(c) an orienting structure configured for coupling said first orienting structure and said second orienting structure in a working orientation; said working orientation orienting said workpiece to present said work site to said operating device appropriately for said performing.

11. An apparatus for fixing a workpiece with respect to a portable operating device for performing an operation at a work site on said workpiece as recited in claim 10 wherein said operating device includes at least one guide rod structure; said at least one guide rod structure participating in guiding said operating device to said work site; and wherein said first orienting structure presents at least one guide rod receiver; said at least one guide rod receiver cooperating with said at least one guide structure to effect said first orientation.

12. An apparatus for fixing a workpiece with respect to a portable operating device for performing an operation at a work site on said workpiece as recited in claim 10 wherein said second orienting structure presents a plurality of structures depending from a substantially planar face; said workpiece being received substantially abutting said face; said plurality of structures cooperating to limit movement of said workpiece in directions generally parallel with said face to effect said second orientation.

13. An apparatus for fixing a workpiece with respect to a portable operating device for performing an operation at a work site on said workpiece as recited in claim 10 wherein the apparatus further comprises at least one clamping unit coupled with at least one of said first orienting structure and said second orienting structure; said at least one clamping unit being configured for urging said workpiece toward said first orienting structure when the apparatus is in said working orientation.

14. An apparatus for fixing a workpiece with respect to a portable operating device for performing an operation at a work site on said workpiece as recited in claim 10 wherein said working orientation is effected by cooperation among a plurality of pin structures received within a plurality of aperture structures; said plurality of pin structures and said plurality of aperture structures being distributed between said first orienting structure and said second orienting structure.

15. An apparatus for fixing a workpiece with respect to a portable operating device for performing an operation at a work site on said workpiece as recited in claim 11 wherein said working orientation is effected by cooperation among a plurality of pin structures received within a plurality of aperture structures; said plurality of pin structures and said plurality of aperture structures being distributed between said first orienting structure and said second orienting structure.

16. An apparatus for fixing a workpiece with respect to a portable operating device for performing an operation at a work site on said workpiece as recited in claim 15 wherein said second orienting structure presents a plurality of structures depending from a substantially planar face; said workpiece being received substantially abutting said face; said plurality of structures cooperating to limit movement of said workpiece in directions generally parallel with said face to effect said second orientation

17. An apparatus for fixing a workpiece with respect to a portable operating device for performing an operation at a work site on said workpiece as recited in claim 16 wherein the apparatus further comprises at least one clamping unit coupled with at least one of said first orienting structure and said second orienting structure; said at least one clamping unit being configured for urging said workpiece toward said first orienting structure when the apparatus is in said working orientation.

18. A method for positioning a workpiece in a predetermined working orientation with respect to a portable operating device when the apparatus is in an assembled orientation; said operating device cooperating with the apparatus to apply at least one operating element to said workpiece at least one predetermined work site when said workpiece is in said working orientation; the method comprising:
(a) in no particular order:
(1) providing a base unit configured for effecting a first cooperative fitting with said operating device in a first orientation;
(2) providing a receiving unit configured for effecting a second cooperative fitting with said workpiece in a second orientation; and
(3) providing an orienting structure configured for effecting a third cooperative fitting said receiving unit with said base unit; and
(b) situating said base unit, said receiving unit and said orienting structure in said assembled orientation.

19. A method for positioning a workpiece in a predetermined working orientation with respect to a portable operating device as recited in claim 18 wherein the method further comprises: providing at least one clamping unit coupled with at least one of said base unit and said receiving unit; and configuring said at least one clamping unit for urging said workpiece toward said base unit when the apparatus is in said assembled orientation.

20. A method for positioning a workpiece in a predetermined working orientation with respect to a portable operating device as recited in claim 19 wherein said third cooperative fitting is effected by cooperation among a plurality of pin structures received within a plurality of aperture structures; said plurality of pin structures and said plurality of aperture structures being distributed between said orienting structure and said receiving unit.
